(19) United States
(12) Patent Application Publication
(10) Pub. No.: US 2009/0289787 A1
(43) Pub. Date: Nov. 26, 2009

(54) RESIDENTIAL SECURITY CLUSTER WITH ASSOCIATED ALARM INTERCONNECTS

(75) Inventors: Christopher James Dawson, Arlington, VA (US); Rick Allen Hamilton, II, Charlottesville, VA (US); Michael David Kendzierski, New York, NY (US); James Wesley Seaman, Falls Church, VA (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 12/124,761

(22) Filed: May 21, 2008

(51) Int. Cl. G08B 21/00

(52) U.S. Cl. 340/540

(57) ABSTRACT

The illustrative embodiments provide a computer implemented method, apparatus, and computer program product for security cluster monitoring and notification. A security cluster comprised of a plurality of structures is monitored for a plurality of events. When an occurrence of an event as defined by a set of parameters associated with a structure in the plurality of structures is identified, information about the event is generated. The information about the event is displayed through a user interface and transmitted to a set of computing devices associated with a set of structures in the plurality of structures.

### BACKGROUND OF THE INVENTION

1. Field of the Invention

The present invention relates generally to an improved data processing system and in particular to security alarm systems. More specifically, the present invention is directed to a computer implemented method, apparatus, and computer usable program code for security cluster alarm systems.

2. Description of the Related Art

Security alarm systems are becoming increasingly popular in residential communities. These systems, common in most residential areas, monitors for detection of events, such as fire, smoke, and intrusion. Still another type of system monitors the status of appliances in the residence, such as water heaters, gas furnaces, freezers, and the like. Similar alarm systems are also utilized in commercial areas. Many of these types of systems operate in association with a central monitoring system, which not only detects when individual systems have been activated, but also determines the status of sensors within the individual systems to ensure that each system remains operative at all times.

A security system uses transmitters and receivers to relay information only between an individual system and a central monitoring system. In order to distinguish between different individual systems when information is relayed to the central monitoring system, each transmitter is coded with information identifying the particular system and the particular sensor transmitting the alert. This information identifies what type of event has been detected, and often corresponds with stored event information in the central monitoring system that indicates specific actions to be taken in response to the event.

### BRIEF SUMMARY OF THE INVENTION

The illustrative embodiments provide a computer implemented method, apparatus, and computer program product for security cluster monitoring and notification. A security cluster comprised of a plurality of structures is monitored for a plurality of events. When an occurrence of an event as defined by a set of parameters associated with a structure in the plurality of structures is identified, information about the event is generated. The information about the event is displayed through a user interface and transmitted to a set of computing devices associated with a set of structures in the plurality of structures.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a residential security cluster responding to an event detection in accordance with an illustrative embodiment;

FIG. 4 is a block diagram of a home alert system detecting an event and sending an alert to systems within the residential security cluster in accordance with an illustrative embodiment;

FIG. 5 is a block diagram of the communication connections between systems in a residential security cluster in accordance with an illustrative embodiment;

FIG. 6 is a block diagram of a table of event triggers with customizable attributes applied to individual home alert systems in accordance with an illustrative embodiment;

FIG. 7 is a flowchart illustrating a process for detecting an event and transmitting an alert in accordance with an illustrative embodiment;

FIG. 8 is a flowchart illustrating a process for receiving an alert by a monitoring system and processing the alert for further transmission in accordance with an illustrative embodiment;

FIG. 9 is a flowchart illustrating a process for receiving an alert by one home alert system from another home alert system and forwarding the alert based on the type of event detected in accordance with an illustrative embodiment; and

FIG. 10 is a flowchart illustrating a process for a security cluster workflow in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media, such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language, such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

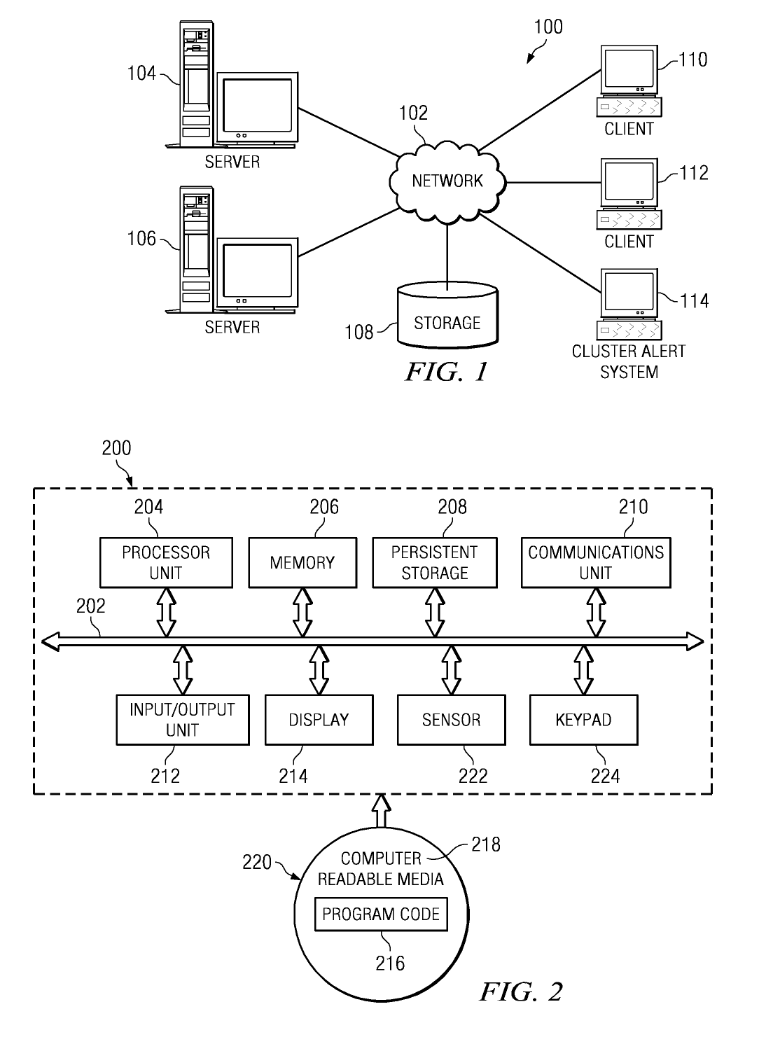

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In this example, server 104 includes a security manager for monitoring cluster alert systems within a residential security cluster. In addition, client 110, client 112, and cluster alert system 114 connect to network 102. Clients 110, client 112, and cluster alert system 114 may be, for example, personal computers or network computers. Cluster alert system 114 is physically located within a structure. The structure may be, without limitation, a residence, retail establishment, office building, or warehouse. A residence is a single or multi-family dwelling, such as, but not limited to, a house, condominium, cabin, dormitory, barracks, or apartment unit. In the depicted example, server 104 provides data, such as boot files, operating system images, and applications to clients 110 and 112, and cluster alert system 114. Clients 110 and 112, and cluster alert system 114 are clients to server 104 in this example. In FIG. 1, cluster alert system 114 includes a security cluster application for permitting cluster alert system 114 to access security manager 310 on server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, display 214, sensor 222, and keypad 224.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user. Sensor 222 identifies the occurrence of an event defined by a set of parameters within a cluster alert system. A set as used herein refers to one or more items. For example, a set of parameters is one or more parameters. Keypad 224 allows a user to input information into the cluster alert system. Information input may include, without limitation, configuration options for the set of parameters defining an event, manual or automated identification of an event, and manual acknowledgment that notification of the event has been received.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

The illustrative embodiments recognize a need for a security cluster with multiple individual cluster alert systems and a central monitoring system wherein each system can transmit and receive information regarding detection of events relevant to the individual cluster alert systems that may be affected by the event.

The embodiments recognize that although current systems can communicate with a central monitoring system, individual systems do not communicate with other individual systems. When an event is detected by an individual system and relayed to the monitoring system, the owner of the structure with the system detecting the event is notified, and possibly appropriate emergency personnel. The embodiments recognize that certain events, such as a fire or intrusion, have effects that impact surrounding structures in addition to the structure with the individual system detecting the event. Current systems do not extend notifications to other owners of structures surrounding the detecting structure. Furthermore, current systems do not provide means for individual systems to relay detection information to other neighboring individual systems in structures that may be affected by the event detected. As a result, structures in proximity with the structure detecting an event are often negatively affected.

Therefore, the illustrative embodiments provide a computer implemented method, apparatus, and computer program product for security cluster monitoring and notification. A security cluster comprised of a plurality of structures is monitored for a plurality of events. When an occurrence of an event as defined by a set of parameters associated with a structure in the plurality of structures is identified, information about the event is generated. The information about the event is displayed through a user interface and transmitted to a set of computing devices associated with a set of structures in the plurality of structures.

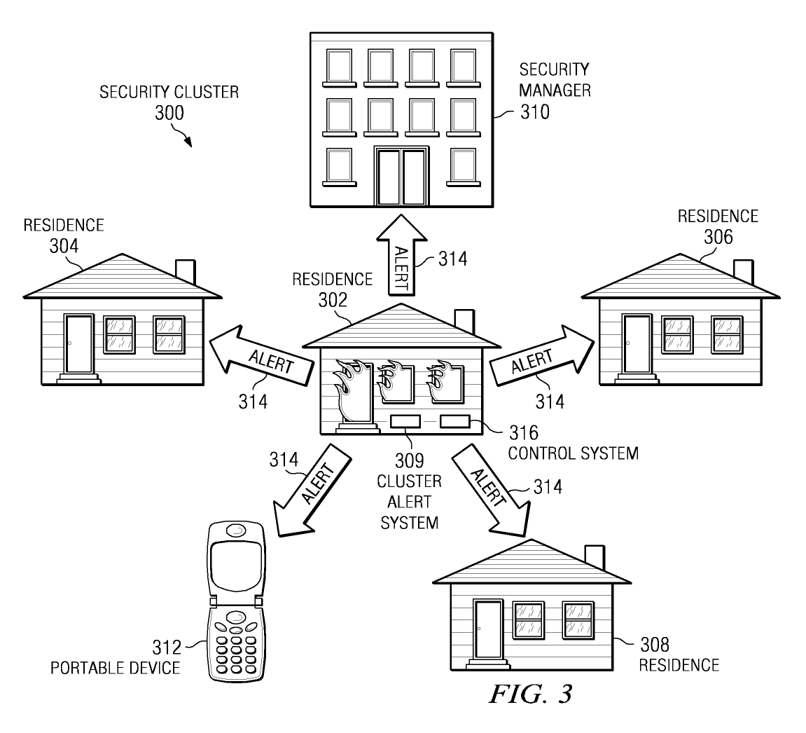

The embodiments in FIGS. 3-9 are described as being implemented in a cluster of residential homes for illustrative purposes only and not intended as any limitation. The embodiments may also be implemented in a cluster of commercial establishments, such as retail buildings, office buildings, or warehouses.

FIG. 3 is a block diagram of a security cluster responding to an event detection in accordance with an illustrative embodiment. Security cluster 300 may be implemented using any type of computing device, including, without limitation, a personal computer, laptop, desktop computer, cell phone, blackberry, personal digital assistant, a server, dedicated computer security appliance, third party gaming console or any other computing device depicted in FIGS. 1 and 2.

Residences 302, 304, 306, and 308 are equipped with cluster alert systems as part of security cluster 300. In this illustrative example, residence 302 is equipped with cluster alert system 309. Residence 302 has a fire that is detected by a sensor, such as sensor 222 in FIG. 2, within cluster alert system 309. Security manger 310 is a monitoring system that monitors cluster alert systems within security cluster 300 for detection of events that activate a cluster alert system. In one embodiment, an event that is detected by a sensor in a cluster alert system is a fire, such as the fire in residence 302. Security manager 310 may be located off-site from the residential area with the security cluster or may be located within the residential area with the security cluster. Portable device 312 is a pervasive portable device that receives information from a cluster alert system. Examples of a portable device include, without limitation, mobile telephones, personal digital assistants, smart watches, personal computers, and laptops. Security cluster 300 allows for bi-directional communication between cluster alert systems and portable device 312.

When the fire in residence 302 is detected by cluster alert system 309, alert 314 is sent to residences 304, 306, and 308, security manager 310, portable device 312, and control system 316. Alert 314 may be transmitted over wires or over a wireless local area network (LAN). Control system 316 is a command system with configurable options for controlling various systems and components in an area, such as, without limitation, electric components, emergency response systems, sprinklers, audible alerts, security systems, and the like. In one embodiment, control system 316 is an integrated system within cluster alert system 309. In another embodiment, control system 316 is a modular system that interacts with cluster alert system 309. Alert 314 contains information regarding the type of event detected and what actions, if any, have been taken by control system 316 in response to the event detection.

In one embodiment, for example, when the event detected is a fire, control system 316 may respond by activating the home sprinkler systems in residence 302. In another embodiment, alert 314 may include, without limitation, a visual alert, audible alert, or data communication alert. In another embodiment, alert 314 may include several different types of notification indicators in a tiered alert process. In a tiered alert process, if the first type of notification is not acknowledged by the home owner, a second type of notification may be sent in addition to the first type of notification, and so on until the home owner sends an indication back to the cluster alert system that the notification has been received.

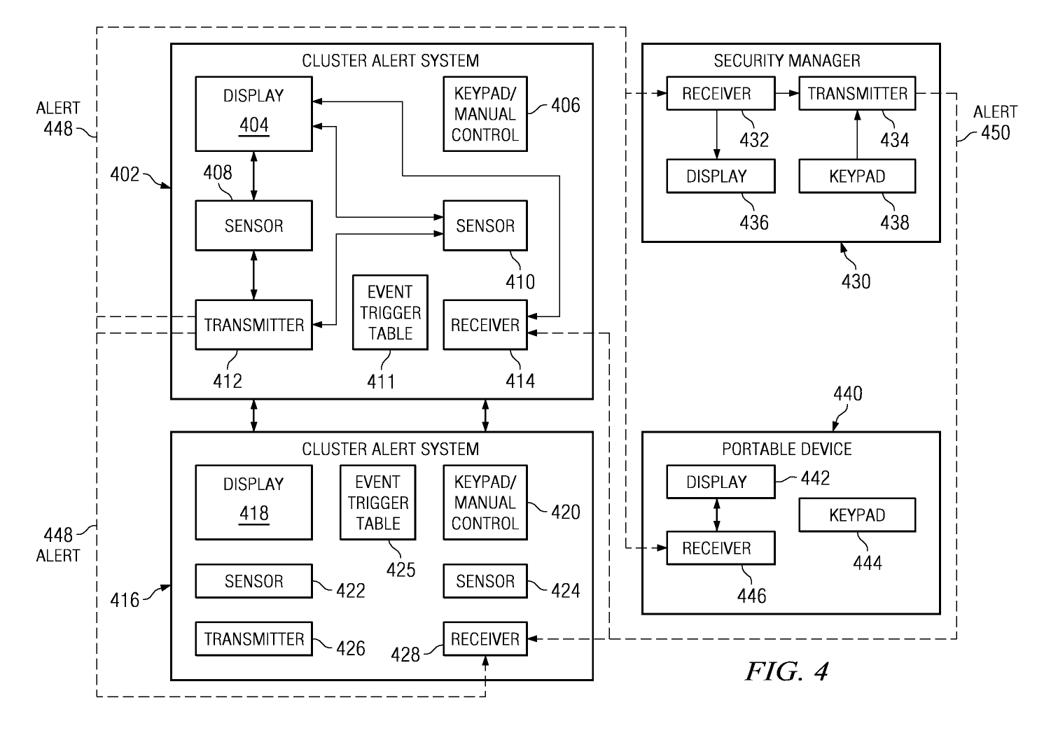

FIG. 4 is a block diagram of a home alert system detecting an event and sending an alert to systems within the residential security cluster in accordance with an illustrative embodiment. FIG. 4 is an example of a cluster alert system, such as cluster alert system 114 in FIG. 1, interacting with a security manager, such as security manager 310 in FIG. 3, and a portable device, such as portable device 312 in FIG. 3.

Cluster alert system 402 consists of display 404, keypad/manual control 406, sensor 408, sensor 410, event trigger table 411, transmitter 412, and receiver 414. Display 404 provides a mechanism to display information regarding an event detection to a user. Keypad/manual control 406 allows a user to input information into cluster alert system 402. Sensors 408 and 410 are configured to detect a specific event. Sensors 408 and 410 interact with event trigger table 411 to determine what threshold constitutes an event based on specific triggers. For example, in one embodiment sensor 408 may be configured to detect a fire, while sensor 410 may be configured to detect an intrusion. Event trigger table 411 may include a threshold of a smoke detection system being activated for the trigger event of a fire, and a threshold of a motion detection system being tripped for the trigger event of an intrusion. When an event is detected, cluster alert system 402 logs the event locally. In one embodiment, an option is provided to automatically log all events centrally at security manager 430 to ensure all logs and alerts are catalogued. In another embodiment, events may be logged locally at cluster alert system 402 without a separate log being created off-site at security manager 430. Transmitter 412 sends information about the event detected by cluster alert system 402 to other devices including, without limitation, cluster alert system 416, security manger 430, and portable device 440. Receiver 414 receives information sent from transmitters in other devices. Cluster alert system 402 analyzes an event based on a set of predefined criteria or custom attributes that correlate to provide an intelligent workflow. Cluster alert system 416 consists of similar components as that of cluster alert system 402, including display 418, keypad 420, sensor 422, sensor 424, event trigger table 425, transmitter 426, and receiver 428.

Security manger 430 consists of receiver 432, transmitter 434, display 436, and keypad 438. Portable device 440 consists of display 442, keypad 444, and receiver 446.

When sensor 408 detects an event, display 404 provides visual information for a user regarding the type of event detected. Transmitter 412 formats the information regarding the type of event detected into alert 448 and sends alert 448 to receiver 428 in cluster alert system 416, receiver 432 in security manager 430, and receiver 446 in portable device 440. In another embodiment, when security manger 430 receives alert 448 from cluster alert system 402, security manager 430 processes the information contained in alert 448 to determine which cluster alert systems within the security cluster, such as security cluster 300 in FIG. 3, should receive an alert with the information from alert 448. Security manger 430 then sends alert 450 to receiver 428 in cluster alert system 416.

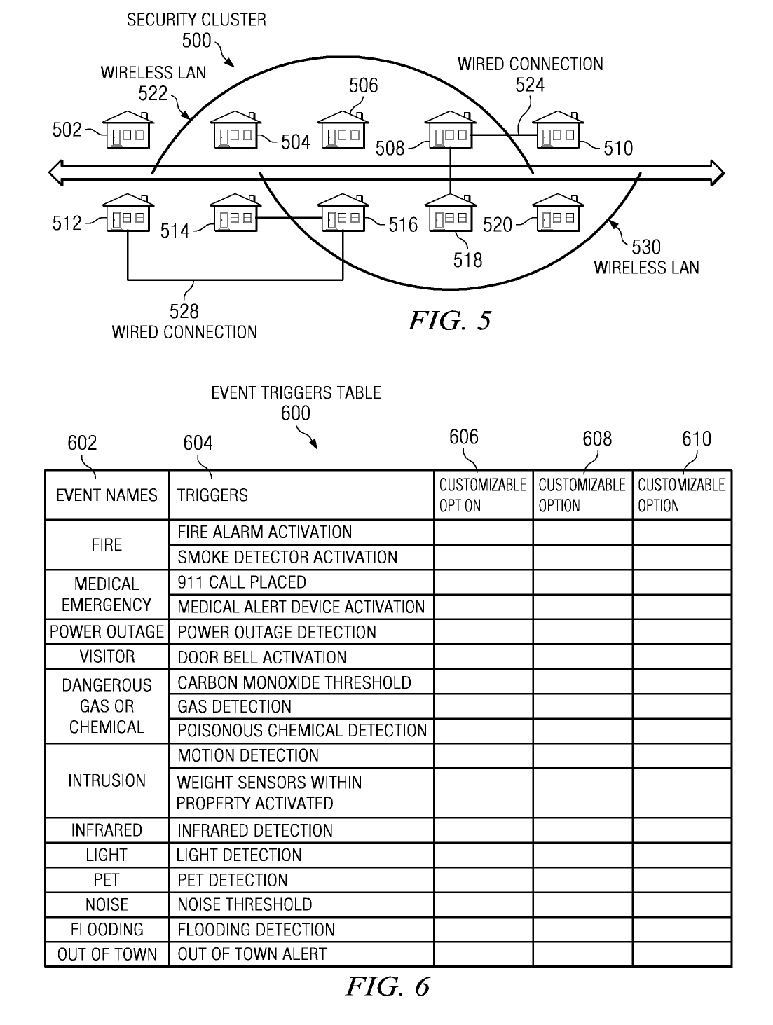

FIG. 5 is a block diagram of the communication connections between systems in a security cluster in accordance with an illustrative embodiment. Security cluster 500 is an example of a security cluster, such as security cluster 300 in FIG. 3. Security cluster 500 consists of residence 502, residence 504, residence 506, residence 508, residence 510, residence 512, residence 514, residence 516, residence 518, and residence 520. Each residence contains a cluster alert system connected to security cluster 500. Residence 504, residence 506, and residence 508, are part of wireless local area network (LAN) 522. Wireless LAN 522 provides wireless connectivity between the cluster alert systems in residences 504, 506, and 508. Residence 508, residence 510, and residence 518 are connected through wired connection 524. Wired connection 524 is a hard wired connection spanning multiple residences that includes, without limitation, fiber, Ethernet, audio cable, and visual data cable. Residences 514 and 516 are connected through wired connection 526. Wired connection 526 is a hard wired connection connecting one cluster alert system to another cluster alert system. Wired connection 528 connects cluster alert systems within residence 512 and 516. Residences 516, 518, and 520 are connected through wireless LAN 530. In one embodiment, both wired and wireless connections are established in security cluster 500 in order to provide redundancy and backup for each system. In the event that wireless LAN 522 encounters trouble or stops working, residence 508 is still connected through wired connection 524 to residences 510 and 518 in order to allow cluster alert systems to communicate.

In one embodiment, an intrusion is detected in residence 506 which activates the cluster alert system in residence 506. The cluster alert system in residence 506 propagates an alert with information regarding the intrusion using wireless LAN 522. Residence 504 and 508 receive the alert with a hop count of 1. A hop count of 1 is an indicator that the alert is from a neighboring house with primary proximity. Because the alert is an intrusion alert, the cluster alert systems in residences 504 and 508 automatically turn on the front porch lights. Residence 508 has a physical connection through wired connection 524 with residences 510 and 518. Because of the physical connection, residence 508 forwards the intrusion alert to residences 510 and 518 with a hop count of 2. A hop count of 2 is an indicator that the alert is from a house within security cluster 500, but with secondary proximity to the residence receiving the hop count of 2. Because the alert is sent with a hop count of 2, the cluster alert systems in residences 510 and 518 notify the respective owners of the alert, but do not take action to turn on the porch lights. Residence 518 is also connected to residences 516 and 520 through wireless LAN 530. Residence 518 uses wireless LAN 530 to transmit the alert with a hop count of 3 to residences 516 and 520. Because the alert is sent with a hop count of 3, the cluster alert systems in residences 516 and 520 log the alert, but do not notify the respective owners or turn on the porch lights.

FIG. 6 is a block diagram of a table of event triggers with customizable attributes applied to individual cluster alert systems in accordance with an illustrative embodiment. Event triggers table 600 is an example of event trigger table 411 within cluster alert system 402 in FIG. 4. Event triggers table 600 contains event names 602, triggers 604, customizable option 606, customizable option 608, and customizable option 610. Examples of events contained in event names 602 include, without limitation, fire, medical emergency, power outage, door bell, dangerous gas, noise, out of town, intrusion, infrared, light, pet, and flooding. Examples of triggers in triggers contained in triggers 604 include, without limitation, fire alarm activation, smoke detector activation, 911 call placed, medical alert device activation, power outage detection, door bell activation, carbon monoxide threshold, noise threshold, out of town alert, motion detection, gas detection, infrared detection, weight sensors within property activation, light detection, pet detection, poisonous chemical detection, and flood detection.

Each event within event names 602 is associated with one or more triggers 604, and one or more customizable options, such as customizable option 606, customizable option 608, and customizable option 610. Examples of customizable options include, without limitation, days of the week alerts should be sent, times of day alerts should be sent, whether alerts should be logged only, whether alerts should be logged and a notification sent to the home owner, whether a specific action should be taken in response to an alert, what type of notification the owner prefers, and the like.

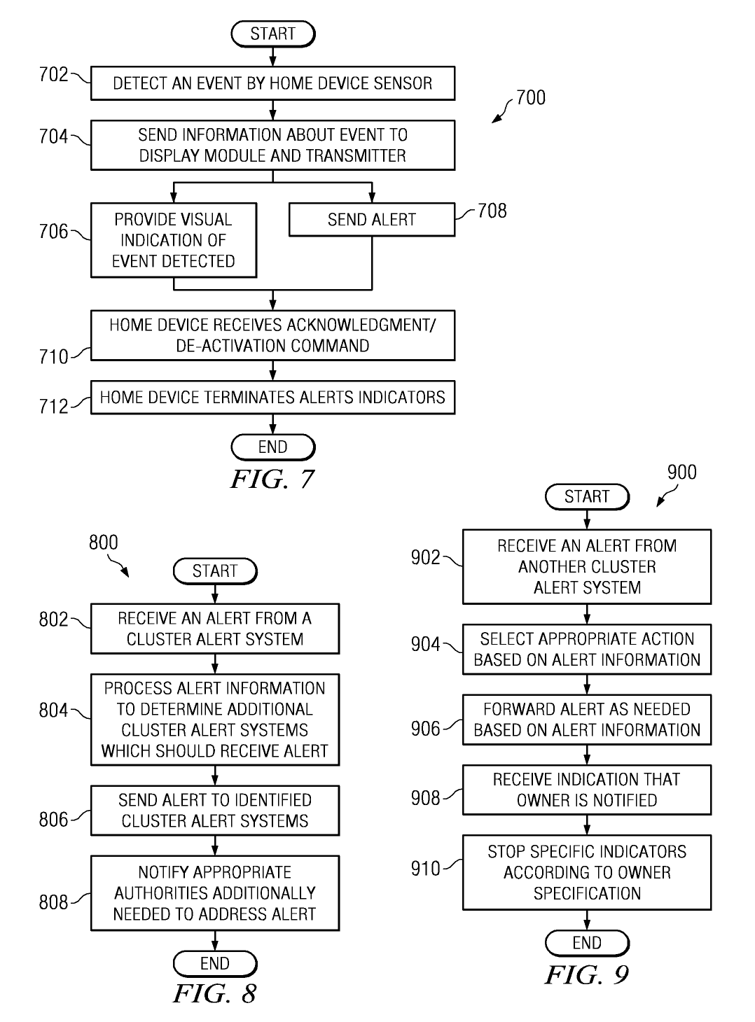

FIG. 7 is a flowchart illustrating a process for detecting an event and transmitting an alert in accordance with an illustrative embodiment. The process in FIG. 7 is implemented by security cluster application software in a cluster alert system, such as cluster alert system 402 in FIG. 4.

The process begins by detecting an event (step 702). The process sends information about the event to a display module and a transmitter (step 704). The process provides visual indication of the event detected via the display module (step 706) and sends an alert via the transmitter (step 708). Next, the process receives acknowledgment or a deactivation command from an end user (step 710). The process terminates the alert indicators (step 712), with the process terminating thereafter.

FIG. 8 is a flowchart illustrating a process for receiving an alert by a monitoring system and processing the alert for further transmission in accordance with an illustrative embodiment. The process in FIG. 8 may be implemented by a software application, such as security manager 430 in FIG. 4.

The process begins by receiving an alert from a cluster alert system (step 802). The process then processes the alert information to determine which additional cluster alert systems should receive the alert (step 804). Next, the process sends the alert to the identified cluster alert systems (step 806) and notifies appropriate authorities needed to address the alert if necessary (step 808), with the process terminating thereafter.

FIG. 9 is a flowchart illustrating a process for receiving an alert by one cluster alert system from another cluster alert system and forwarding the alert based on the type of event detected in accordance with an illustrative embodiment. The process in FIG. 9 may be implemented by a software application, such as cluster alert system 416 in FIG. 4.

The process begins by receiving an alert from another cluster alert system (step 902). The process selects an appropriate action to initiate based on the alert information (step 904). Next, the process forwards the alert as needed to additional cluster alert systems based on the alert information (step 906). The process receives an indication that the owner of the residence is notified of the alert (step 908) and stops specific indicators according to owner specifications (step 910), with the process terminating thereafter.

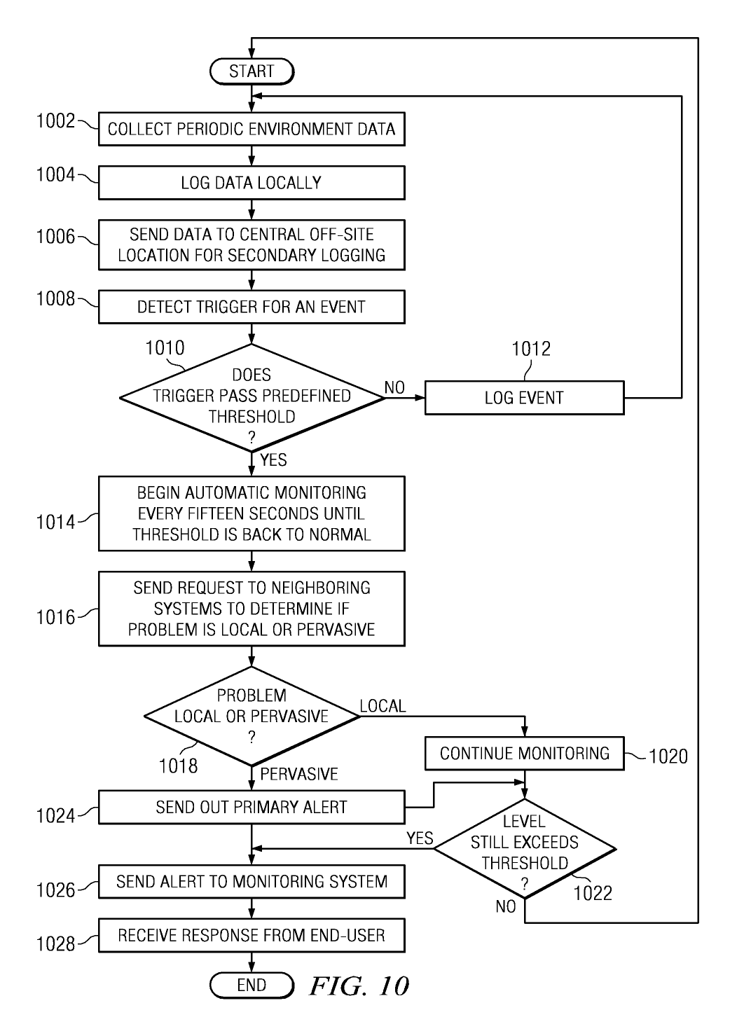

FIG. 10 is a flowchart illustrating a process for a security cluster workflow in accordance with an illustrative embodiment. The process in FIG. 10 may be implemented by a software application, such as cluster alert system 402 in FIG. 4.

The process begins by collecting periodic environmental data (step 1002). The process logs data locally (step 1004) and sends data to a central off-site location for secondary logging (step 1006). When the process detects a trigger for an event (step 1008), the process determines whether the trigger passes a predefined threshold (step 1010). If the trigger does not pass a predefined threshold, the process logs the event (step 1012) and returns to step 1002. If the trigger passes a predefined threshold, the process begins automatic monitoring every fifteen seconds until the threshold is back to normal (step 1014). Next, the process sends a request to neighboring systems to determine if the problem is local or pervasive (step 1016). The process determines whether the problem is local or pervasive (step 1018). If the problem is local, the process continues monitoring (step 1020), then determines whether the level still exceeds the threshold (step 1022). If the level no longer exceeds the threshold, the process returns to step 1002. If the level still exceeds the threshold, or the process determines the problem is pervasive, the process sends out a primary alert (step 1024). Next, the process sends the primary alert to the off-site monitoring system (step 1026). The process then receives a response from an end-user (step 1028) with the process terminating thereafter.

Thus, the illustrative embodiments provide a computer implemented method, apparatus, and computer program product for security cluster monitoring and notification. A security cluster comprised of a plurality of structures is monitored for a plurality of events. When an occurrence of an event as defined by a set of parameters associated with a structure in the plurality of structures is identified, information about the event is generated. The information about the event is displayed through a user interface and transmitted to a set of computing devices associated with a set of structures in the plurality of structures.

The illustrative embodiments provide the means for one or more structures to communicate with the occupants or owners of another structure when an event of interest occurs. Such communication could occur between fixed devices within the structure, such as invasion alarm systems, between a fixed device and a pervasive device, or between discreet portable pervasive devices. The data communication may be wired or wireless access between the structures and potentially both in order to provide fail-over and availability for the grid system of structures.

Each structure within the grid system participating in the security cluster may monitor one or more structures to provide fail-over and redundancy of the monitoring environment for each structure within the grid. This redundancy of each structure watching multiple structures provides a backup system if there is a data communication failure between structures or systems. Each structure may monitor and regulate a variety of different systems within a structure using individual sensors that can communicate with a central control system. Individual parameters and thresholds may be established for each structure in order to provide the customization per parameter that will be monitored individually and within the group of structure.

Transmission of such security information in a peer-to-peer fashion provides for a safer and more tightly coupled community. Such security clusters may allow, with selective privacy measures in place, structures within the cluster to be quickly alerted of fires, break-ins, and other security issues that may impact the community as a whole. By allowing each structure to act as a monitoring unit within a group, structures within the group are brought into a more secure and safe environment as part of the group. With safety in numbers and the ability for multiple structures to check and monitor each structure within the group, threats, such as, but not limited to, theft, fire, carbon monoxide poisoning, neglect, or violence are all reduced as the group provides monitoring and communication between each structure in the group. Additionally, the grid system allows for multiple structures to signal problems to the appropriate authorities rather than having to rely on the system of one structure only. Structures that participate in a security cluster have the added benefit of lowering the perceived ability for criminals to target an individual structure. If a criminal knows a certain structure or group of structures is protected and monitored by multiple external systems, the community may be at a lower risk for crime, resulting in improved safety overall.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for security cluster monitoring and notification, the computer implemented method comprising:
monitoring for a plurality of events in a security cluster, wherein the security cluster comprises a plurality of structures;
identifying an occurrence of an event defined by a set of parameters associated with a structure in the plurality of structures, wherein identifying the occurrence of the event includes receiving information describing a detection of at least one trigger of the event, and wherein a sensor sends the information describing the detection of the at least one trigger of the event;
identifying a threshold for the at least one trigger of the event;
determining whether the threshold for the at least one trigger of the event is met or exceeded;
generating information about the event;
displaying the information about the event to a computing device in a set of computing devices associated with a set of structures in the plurality of structures; and
responsive to exceeding the threshold for the at least one trigger of the event, transmitting the information about the event to the set of computing devices associated with the set of structures in the plurality of structures.

2. The computer implemented method of claim 1, wherein generating information about the event further comprises:
receiving, from the sensor, data describing the event, wherein the data about the event includes the trigger and the threshold detected by the sensor; and
processing the data about the event using a knowledge repository wherein the knowledge repository includes a table of a plurality of triggers, wherein each trigger in the plurality of triggers is associated with at least one action command.

3. The computer implemented method of claim 2, wherein the knowledge repository logs the data about the event in association with a user response to the event to form learned data about the event, and wherein the learned data about the event is used to process data responsive to a reoccurrence of the event.

4. The computer implemented method of claim 1, wherein displaying the information about the event further comprises:
converting the information about the event into a human-readable format to form display information; and
providing the display information to an end-user through a user-interface.

5. The computer implemented method of claim 1, wherein the set of computing devices associated with the set of structures includes an individual cluster alert system, a control system, and a central monitoring system, wherein the individual cluster alert system is located in a structure other than the structure detecting the event, wherein the control system is an automated control system within the structure detecting the event, and wherein the central monitoring system is located off-site from the security cluster.

6. A computer program product for security cluster monitoring and notification, the computer program product comprising:
computer usable program code for monitoring for a plurality of events in a security cluster, wherein the security cluster comprises a plurality of structures; computer usable program code
computer usable program code for identifying an occurrence of an event defined by a set of parameters associated with a structure in the plurality of structures, wherein identifying the occurrence of the event includes receiving information describing a detection of at least one trigger of the event, and wherein a sensor sends the information describing the detection of the at least one trigger of the event;
computer usable program code for identifying a threshold for the at least one trigger of the event;
computer usable program code for determining whether the threshold for the at least one trigger of the event is met or exceeded;
computer usable program code for generating information about the event;
computer usable program code for displaying the information about the event to a computing device in a set of computing devices associated with a set of structures in the plurality of structures; and
computer usable program code for, responsive to exceeding the threshold for the at least one trigger of the event, transmitting the information about the event to the set of computing devices associated with the set of structures in the plurality of structures.

7. The computer program product of claim 6, wherein generating information about the event further comprises:
computer usable program code for receiving, from the sensor, data describing the event, wherein the data about the event includes the trigger and the threshold detected by the sensor; and
computer usable program code for processing the data about the event using a knowledge repository, wherein the knowledge repository includes a table of a plurality of triggers, wherein each trigger in the plurality of triggers is associated with at least one action command.

8. The computer program product of claim 7, wherein the knowledge repository logs the data about the event in association with a user response to the event to form learned data about the event, and wherein the learned data about the event is used to process data responsive to a reoccurrence of the event.

9. The computer program product of claim 6, wherein displaying the information about the event further comprises:
computer usable program code for converting the information about the event into a human-readable format to form display information; and
computer usable program code for providing the display information to an end-user through a user-interface.

10. The computer program product of claim 6, wherein the set of computing devices associated with the set of structures includes an individual cluster alert system, a control system, and a central monitoring system, wherein the individual cluster alert system is located in a structure other than the structure detecting the event, wherein the control system is an automated control system within the structure detecting the event, and wherein the central monitoring system is located off-site from the security cluster.

11. A computer implemented method for security cluster monitoring and notification, the computer implemented method comprising:
monitoring for a plurality of events in a security cluster, wherein the security cluster comprises a plurality of residences;
identifying an occurrence of an event defined by a set of parameters associated with a residence in the plurality of residences, wherein identifying the occurrence of the event includes receiving information, from a sensor, describing a detection of at least one trigger of the event;
identifying a threshold for the at least one trigger of the event;
determining whether the threshold for the at least one trigger of the event is met or exceeded;
generating information about the event, wherein generating information about the event further comprises processing the information describing the detection of the at least one trigger of the event and the threshold using a knowledge repository, wherein the knowledge repository includes a table of a plurality of triggers, wherein each trigger in the plurality of triggers is associated with at least one action command, wherein the knowledge repository logs the data about the event in association with a user response to the event to form learned data about the event, and wherein the learned data about the event is used to process data responsive to a reoccurrence of the event;
displaying the information about the event to a computing device in a set of computing devices associated with a set of residences in the plurality of residences, wherein displaying the information about the event further comprises:
converting the information about the event into a human-readable format to form display information; and
providing the display information to an end-user through a user-interface associated with the computing device; and
responsive to exceeding the threshold for the at least one trigger of the event, transmitting the information about the event to the set of computing devices associated with the set of residences in the plurality of residences, wherein the set of computing devices associated with the set of residences in the plurality of residences includes an individual cluster alert system, a control system, and a central monitoring system, wherein the individual cluster alert system is located in a residence other than the residence detecting the event, wherein the control system is an automated control system within the residence detecting the event, and wherein the central monitoring system is located off-site from the security cluster.
